(19) United States
(12) Patent Application Publication
(10) Pub. No.: US 2016/0368187 A1
(43) Pub. Date: Dec. 22, 2016

(54) METHOD FOR PRODUCING PLASTIC COMPONENTS, WHICH HAVE A HIGH MECHANICAL LOAD-BEARING CAPACITY, WITH A CORRECT FINAL CONTOUR

(71) Applicant: KRAUSSMAFFEI TECHNOLOGIES GMBH, München (DE)

(72) Inventors: MARTIN SCHNEEBAUER, München (DE); MARTIN WUERTELE, Friedberg (DE)

(73) Assignee: KRAUSSMAFFEI TECHNOLOGIES GMBH, München (DE)

(21) Appl. No.: 14/901,935

(22) PCT Filed: Jul. 25, 2014
(86) PCT No.: PCT/EP2014/066114

§ 371 Date: Dec. 29, 2015

(30) Foreign Application Priority Data
Jul. 26, 2013 (DE) 10 2013 107 991.1

(51) Int. Cl. B29C 45/00

(52) U.S. Cl. CPC B29C 45/0005; B29K 2101/12

(57) ABSTRACT

A method for producing plastic components, which have a high mechanical load-bearing capacity, with a correct final contour is disclosed. In the method an injection casting process is carried out in a first step using a thermoplastic molding compound in a closed tool consisting of a female die and a male die, a thermoplastic molding compound with a high viscosity being used in order to provide a sufficient seal of the tool or the cavity at the tool parting plane between the female die and the male die in comparison to a molding compound with an extremely low viscosity used in a second step. The cavity is increased prior to the second step such that the seal formed by the molding compound is fixed on or in the molding compound with the extremely low viscosity after said molding compound is injected and cured to such an extent that the molding compounds forms a composite component.

The present invention relates to a method for producing plastic components which have a high mechanical load-bearing capacity, with a correct final contour.

Plastic components which have a high mechanical load-bearing capacity are preferably produced from thermosetting materials. These materials are characterized in the injection casting process by reactive materials which are very highly fluid or respectively have a low viscosity, which brings about a strong tendency to the formation of burrs at least on a tool parting plane between the individual components of a respective injection casting tool.

Thermosetting materials undergo a further mechanical strengthening with the use in combination with fibres as so-called fibre composite components. Fibre composite components comprise, with a bedding matrix and reinforcing fibres, generally only two main components. Through reciprocal interactions of these two components, a fibre composite component is given higher quality characteristics than each of the two individual components involved. The extremely thin fibres, having high tensile strength, contribute here through their density and targeted alignment of their filaments quite substantially to the strength of a customized fibre composite component.

Reference is also made below, as a method for the production of plastic components which have a high mechanical load-bearing capacity, to the resin transfer moulding or respectively abbreviated RTM method for the production of fibre-reinforced plastic components, without the present invention being restricted to this case of application. The production of components from a thermoset material takes place in the RIM method in components with complex geometry via so-called preforms. Preforms are understood to mean prefabricated fibre bodies, which are subsequently inserted into an opened tool. The preform is placed here generally over the edges of the finished component cavity of the tool and the textile projects accordingly into the parting plane of the tool. A seal in the parting plane takes place in a known method then via a circumferential sealing cord, which is to be previously inserted separately into the mould. This technique enables very homogeneous permeability in the textile structure during the impregnating of the textile with the matrix.

The impregnating of the textile is influenced by the viscosity of the resin system and the permeability of the fibre material. The temperature of the moulding tool and/or of the resin determine, in addition to the permeability of the fibre material, the flow paths, through which the impregnating of the textile can be optimized. However, a burr-free manufacture, with a correct final contour, is not able to be achieved with a variation of these parameters.

The manufacture of RTM components involves a great effort in terms of production engineering. Here, in addition to the complex preform process, the component must be further subsequently processed after the resin infusion and the curing, and brought into the final contour. This trimming frequently takes place by laser beam cutting or water jet cutting, wherein cured fibre/plastic composite or respectively abbreviated FPC occurs as offcut material which can scarcely be used again by the recycling methods of the prior art. This additional manufacturing step also means higher component costs.

After the trimming of the component, the sharp edges and the fibre ends lie freely on the edges of the fibre composite material. In order to prevent a diffusion of moisture into the cut edges, these must be additionally sealed if necessary, which constitutes an additional extra expenditure in terms of material and processing time in the manufacture.

A further disadvantage of known methods lies in that in the case of too great a tolerance between the inserted preform and the tool edge during the injection, the low-viscosity reactive component can run ahead on the tool wall. As a result, air is then generally included in the preform.

With a new manufacture close to final contour or respectively close to final dimension, also designated as “near net shape” technology, the aim is pursued of producing performs with a correct contour, which correspond to the final contour of the component to such an extent that time-consuming and very costly further processing steps can be avoided. In order to achieve a stable and reproducible RTM process, it must be ensured that the initial parameters are always the same. In addition to the rheological characteristics of the matrix, above all the quality of the preform with regard to geometry and permeability is relevant. This is achieved on the one hand by an automated preforming close to the final contour. Further advantages of the “near net shape” type of construction result through a considerable reduction of downstream processing methods, such as contour milling and cut edge sealing.

New technologies are beginning to trim the textile preform finely in advance. Here, the shaped textile, after the preform process, is cut for example with a laser and placed into the mould with a close tolerance. This method, developed by the DLR (German Aerospace Centre) and also designated as “Evo RTM” for the manufacture of complex CFRP (carbon fibre reinforced plastic) structures as volume components near to final contour in high numbers of units is, however, laborious to a high extent and therefore is suitable only for comparatively smaller piece numbers, as are to be found for example in the aircraft industry.

Furthermore, special textile technologies are known from the prior art, which enable a defined edge termination of the preform.

As a possibility for improvement in the manufacture of RTM components, a method is known from DE 696 07 445 T2 or respectively EP 0 780 213 B1. This approach is also to offer a solution against the risk of the running head of the reactive component on tool edges and therefore the including of air in the workpiece which is to be produced in that after the inserting of a dry preform, a thermally activatable, swellable adhesive is arranged between the injection mould and the preform along at least one edge of the component which is to be produced and, after the closing of the injection mould, is activated by heating of the entire tool. Only subsequently is resin introduced into the closed mould and polymerized, so that the swollen, polymerized adhesive is an integral component part of the finished component. However, in particular in a region of a tool parting plane in the form of the polymerized adhesive without fibre addition, the tool displays entirely different mechanical parameters than are shown by the remaining RIM component.

An automated manufacture of planar components, such as e.g. passenger car roofs, mudguards or engine bonnets, is already prior art. The requirement for automation in the production of FPC (fibre plastic composite) components is increasingly cost-driven, however also reproducibility, traceable and robust processes with the best utilization of the potential for lightweight construction are drivers for a complete automation.

The present invention has the aim of providing a method for producing plastic components which have a high mechanical load-bearing capacity with a correct final contour, which mitigates the above-mentioned disadvantages of known methods in particular with regard to a costly further processing, and at the same time to increase a load-bearing capacity of an area around a tool parting plane.

This problem is solved according to the invention by the features of claim 1, in that a method for the production of plastic components which have a high mechanical load-bearing capacity, with a correct final contour, in which firstly in a first step in a closed tool consisting of a female die and a male die an injection casting process is carried out using a thermoplastic moulding compound, in which a thermoplastic moulding compound with a high viscosity is used, in order to provide a sufficient seal of the tool or respectively the cavity at the tool parting plane between the female die and the male die with respect to a moulding compound K2 with a low viscosity used subsequently in a second step, is characterized in that before the second step the cavity of the tool is increased such that after the injecting and curing of the moulding compound with the very low viscosity, a seal formed by the thermoplastic moulding compound is fixed on or respectively in the moulding compound with the very low viscosity to such an extent that they form a composite component.

In a first step, in the closed tool an injection casting process is carried out with a thermoplastic moulding compound, in which a thermoplastic moulding compound with a high viscosity is used, in order to provide a sufficient seal of that of the tool or respectively of the cavity in the tool parting plane between the female die and the male die with respect to the moulding compound with very low viscosity injected into the tool in a second step. The thus resulting composite component can also be further regarded homogeneously as a thermosetting component, approximately instead of as a composite component, from the mechanical characteristics, owing to the fact that a portion of thermoplastic plastic is concentrated on a narrow zone at a tool parting plane or respectively parting line. In addition, the seam-like sealing region on the finished component has at least the mechanical characteristics of the first plastic used or respectively of the thermoplastic moulding compound.

According to the invention, therefore with the combination of the processes for the treatment of reactive moulding compounds with the injection casting of thermoplastic moulding compounds, an injection casting tool can also be sealed very well in a tool parting plane. The comparatively highly viscous thermoplastic material prevents here the formation of a burr, which would have to be subsequently processed after hardening of a moulding compound with low viscosity and after the opening of the tool. A resulting component according to the method described above is therefore distinguished in that it is surrounded by a thermoplastic edge in the region of the tool parting plane between the female die and the male die. Hereby, on the one hand, a generally sufficient contour accuracy of the finished component is also already achieved in the region of a tool parting plane with the removal from the tool, on the other hand, any subsequent treatments on a thermoplastic material are able to be carried out substantially more simply and economically, therefore described above with regard to a thermosetting material.

Advantageous further developments are the subject of the subclaims. Accordingly, an increasing of the cavity is preferably carried out by moving at least one movable block or by associating of the male die to another female die or an analogous change is carried out. In the alternative with a change of the female die, however, care is to be taken that an association of a second female die takes place with defined stamping edges for the form-fitting seal of the cavity. A thickness of a material of the thermoplastic seal which is to be stamped should be approximately 0.2-0.3 mm here, i.e. a defined stamping edge on the second female die should have a depth of approximately 0.2-0.3 mm with a width of approximately 1 mm to 2 mm.

In a particularly preferred embodiment of the invention, an inserted dry textile or respectively a preform is fixed by the thermoplastic plastic in a first step firstly in shape and position. The first used thermoplastic plastic forms, in addition to the function as a frame-shaped seal in the tool parting plane virtually a frame in which the textile is fixed. In contrast to the conventional RTM technique, in a method according to the invention therefore also a seal of the tool is also achieved with respect to the moulding compound with very low viscosity for the impregnating of the textile structure or respectively its individual filaments in the tool by a further component of thermoplastic plastic, which is injected in a first step. For sealing a cavity in the tool parting plane with respect to an injected thermoplastic material, recourse can be made to known approaches in tool manufacture. Additional measures for sealing, in particular the inserting of sealing cords etc., are therefore superfluous. The combination of the injection of thermoplastic and reactive moulding compounds per se is already known and is used for example for the coating of thermoplast components. The combination for use of the first component as fixing of an inserted textile preform, which is subsequently impregnated with a further moulding compound with low viscosity is only possible on the basis of a knowledge forming the basis of the present invention, according to which, owing to the high viscosity, an impregnating of the textile preform by the thermoplastic plastic is, however, not possible or is only possible in a very limited manner, so that maximally the first two to three filament layers on the surface of the preform can be completely encased by the thermoplastic plastic composition. The circumferential edge of the component is accordingly injected around completely with thermoplastic material, in order to be used subsequently for sealing the cavity with respect to the reactive component, which is comparatively very much more highly fluid.

Advantageously, in a preferred embodiment of the invention, a gas injection into the thermoplastic material is provided. Thereby, the viscosity of the thermoplastic material is reduced, so that in addition to a saving of thermoplastic material, one can also work with lower injection pressures.

An aim of the present invention consists in maintaining via an exact production and an exact deposition of a preform in the respective tool a tolerance limit of approximately 0.1 mm difference between preform and tool cavity, in order to thereby also make subsequent further processings superfluous. For this, the textile insert or preform is configured so that it can be placed in a cavity of the tool within close tolerance limits of approximately 0.5-approximately 1.0 mm. For the manufacture of preforms from different materials itself, reference is to be made to the disclosures of WO 99/12733 A1 and U.S. Pat. No. 7,247,212 A. Provision is made furthermore in an embodiment of the invention to fix the textile structure or respectively the preform in its position in the opened cavity with the use of special elements, such as for example needles or push-pull arrangements, so that an undesired slipping or displacing of the insert, e.g. on closing of the tool, can be prevented.

According to a preferred embodiment of the invention, the inserted preform or the textile forms towards the edge of the cavity a gap which is adjustable in a defined manner, which is adjusted in an oriented manner to the flow path/wall thickness ratio of the thermoplast which is to be processed and to the sprue situation.

Preferably, the injecting around of the dry textile takes place in a first step with the thermoplastic plastic such that the textile is partially or completely surrounded by plastic. In an embodiment of the invention, ribs and other functional elements of the subsequent component, in which the mechanical characteristics of a short glass fibre reinforced thermoplastic plastic material are sufficient, likewise injected directly onto the textile, which as an insert is itself only capable for the formation of flat structures and not for that of functional elements.

In a preferred embodiment of the invention, a stamping/pressing takes place of the circumferential sealing edge formed after the introduction of the thermoplast, via machine stamping or a tool-integrated stamping technique. Thereby, the shrinkage of the thermoplast system can be compensated, wherein at the same time a complete seal is ensured. In a further variant of the method, this stamping process is superimposed with the injection of the impregnation component, in order to enable a better venting of the system.

In a further step, then in the same or in a new cavity a further component with low viscosity, the impregnation component, can be injected, with which the textile insert is impregnated. For this, via a separate sprue point, a further plastic component is used, in particular a reactive moulding compound with preferably similar chemical characteristics to the previously injected thermoplastic moulding compound. The low viscosity enables an impregnation and largely complete penetration of the textile preform and subsequently cures via a chemical or physical reaction in the closed mould. Through the partial or complete surrounding of the dry textile with a thermoplastic previously taking place, the dry textile during this step is still fixed as by a frame in the cavity, which prevents a displacing of the textile during the subsequent injecting of a reactive moulding compound. Therefore, distinctly faster injection speeds of the reactive moulding compound can be realized than are known in a standard RTM process.

The flow front of the impregnation component terminates at the component edge on the previously injected thermoplastic sealing edge. By means of an additional stamping of the thermoplastic plastic, a complete tightness can be achieved, which is already used by the applicant in a targeted manner in its method known as ColorForm with downstream lacquering of a thermoplastic carrier with a 2-component lacquer system in a closed tool and therefore is also able to be used for the specialist within the present invention. Therefore, a complete automation of the demoulding of the component and hence of the entire process is possible. No additional manual cleaning work is necessary in the mould.

In an alternative variant of the method, in a separate cavity exclusively the rib structure of thermoplastic material is injected and cured. The mould is opened and the so far finished component remains in a mould half. A third mould half is now associated with this mould half, with which third mould half a cavity can form for the part structure. Into the provided cavity, a dry textile is inserted into the cavity of the injection casting component provided for this and subsequently the mould is closed with the aid of a third tool half. Here, owing to the selected tolerances of the mould halves, the shrinkage of the thermoplast is taken into consideration, so that in the seal region of the tool a press fit takes place between the tool steel and the thermoplastic plastic component. Subsequently, a plastic with low viscosity is injected into the cavity which has arisen, in which the dry textile is situated. The advantage of the alternative variant lies in that the textile insert is not compacted or respectively compressed in the region of the contact points with the component K2. Through a compacting and densification of the textile material, different permeabilities can occur, which lead to an irregular filling process with a non-complete impregnating of the textile material.

Further features and advantages of embodiments according to the invention are explained in further detail below with reference to example embodiments with the aid of the drawings. Therein there are shown in diagrammatic illustration:

FIG. 1: a sectional illustration through a tool for the production of a plastic component which has a high mechanical load-bearing capacity in the form of a fibre composite component in a multi-component injection casting process;

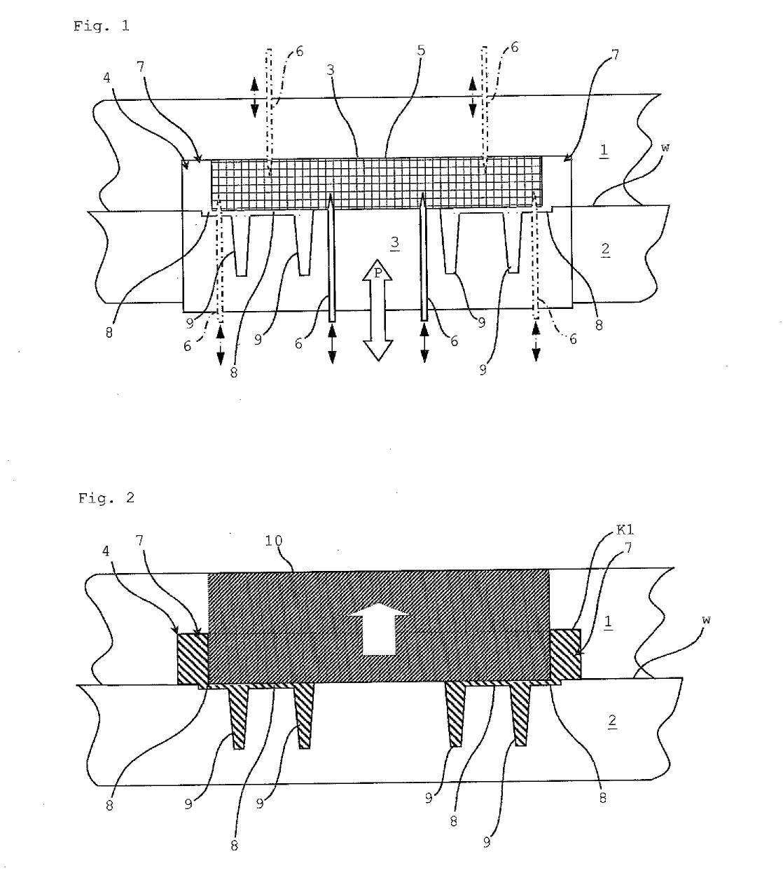

FIG. 2: a sectional illustration of a further example embodiment;

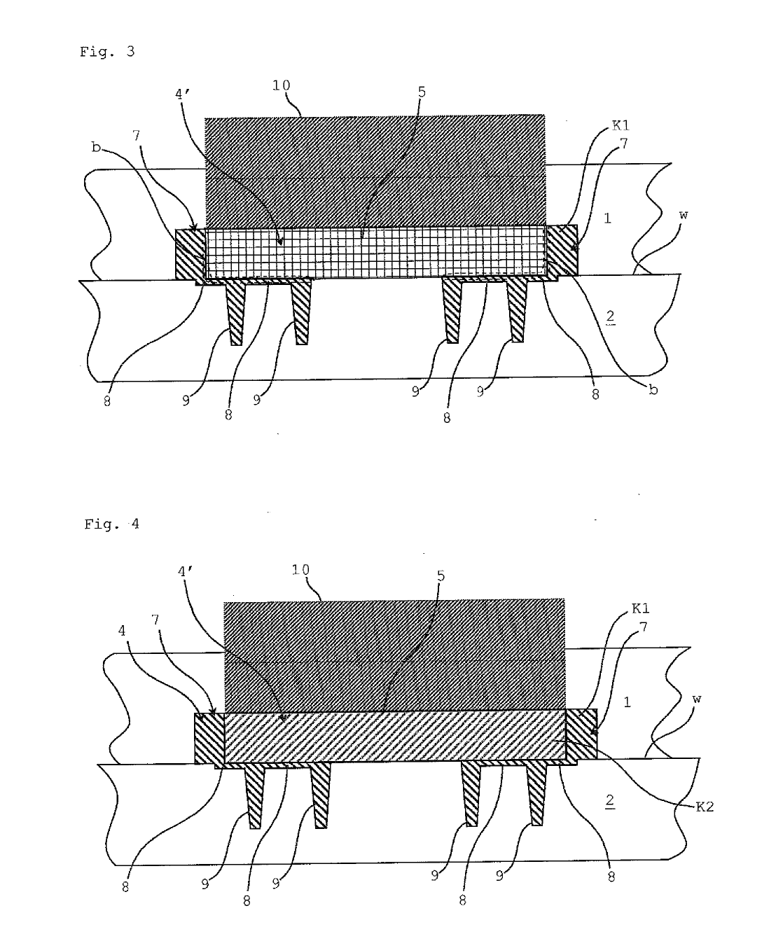

FIG. 3: a sectional illustration analogous to the illustration of FIG. 2 to illustrate a tool change and

FIG. 4: the sectional illustration of FIG. 3 to illustrate a final method step.

The same reference numbers are always used for identical elements throughout the various illustrations. Without restriction to the invention, only variants for the production of fibre composite components are dealt with below in the drawings, wherein at least one textile insert is impregnated with a thermosetting plastic with very low viscosity for the formation of a component which is near to The close contour as possible. A method according to the invention can also be used for a production of components which do not comprise any textile inserts, but nevertheless are to be produced as thermosetting components which are as near to the close contour as possible, in particular in order to largely save the expenditure of time and costs of a further processing in a tool parting plane.

A first example embodiment shows in the illustration of FIG. 1 a fibre composite component as an example for a plastic component which has a high mechanical load-bearing capacity, which is produced by means of the multi-component injection casting method. The moulding tool consists here of a female die 1 and a counter-piece, a male die 2. The female die 1 and male die 2 form in the closed state of the tool a tool parting plane w with one another.

In a variant of the method, the male die 2 itself can have a core 3 movable in the direction of the arrow P, which permits a stamping/pressing of the components, as indicated in the illustration of FIG. 1. Hereby, a change to a cavity 4 enabled also subsequently with reference to a corresponding functional widening of the female die 1 or respectively creation of an enlarged cavity 4′ is described, see FIGS. 2 and 3.

In the closed state, the two mould halves form at least one cavity 4. Into this cavity 4 either a textile preform, which was produced in a previous step, or a corresponding textile structure 5 is inserted and the mould is closed.

Via optional fixing elements 6 integrated into the tool, which are mounted movably in the present example, a displacement or slipping of the textile insert or respectively of the textile structure 5 is prevented. These optional elements 6 are constructed here in needle form. They can be provided in the female die 1 and/or in the male die 2. Such devices have also been known for a long time to the specialist in the art in the form of holding clamps etc. and are therefore not embodied here further as means of choice.

Towards the edge of the cavity 4, the textile insert 5 forms with the moulding tool of female die 1 and male die 2 an empty space 7. On inserting a textile into the first cavity of the injection casting tool, an edge between textile insert and tool cavity of 2-3 mm is to be maintained. Therefore, also larger components can be reliably filled.

Here, the empty space 7 is filled via at least one injection point, which is not further illustrated, with a thermoplastic plastic component K1. A number of injection or respectively sprue points for the thermoplastic component K1 is to be adapted to the flowability of a respective plastic. A flow path/wall thickness ratio of 100-150 is to be maintained.

Substrates capable of injection casting suitable for the first component K1 are easily flowing thermoplasts with a shear-rate-dependent viscosity of approximately 10-150 Pa*s. In particular, technical plastics such as polyamides with glass fibre- or carbon fibre reinforcement come into consideration here, with which in the first method step layer thicknesses of approximately 2 mm are built up in the region of the tool parting plane w. Through an additional physical foaming process, the viscosity of the plastic can be further reduced and in addition the mould filling pressures can be reduced, in order to prevent a displacement of a textile insert also in the case of very small edge cavities.

Furthermore, in the present example in the cavity 4 in addition ribs 9, adjoining thereon, and other flow path aids 8 are provided, which enable a uniform filling of the mould and a partial surrounding of the textile insert or respectively of the textile structure 5 and thus serve for a further increase of the strength of the component which is to be produced. In particular, the ribs 9 are formed by the thermoplastic plastic component K1, which in addition can also be obtained in a fibre-reinforced manner by the admixing of shorter glass fibre pieces. However, no fibres could be admixed to a subsequently injected reactive component, because these would be virtually filtered out on penetrating and impregnating of the textile structure 5. A textile structure 5 can basically not form such ribs 9, because it can only, rather, form flat bodies.

On injecting of a plastic component K1, the cavities 7, 8 and 9 are filled with plastic composition and cure at least partially. This component K1 is constituted such that in the tool parting plane w between female die 1 and male die 2 it brings about a seal corresponding to the prior art and no or only slight further subsequent processing of the component is necessary after completion of the injection process, in order to achieve a sufficient correct contour.

During injecting of the plastic component K1, the textile insert 5 is saturated here only on the outermost filament structures by the plastic component K1 into a region of a thickness b, indicated by dashed lines. With the solidifying of the plastic component K1, the textile insert 5 is surrounded by a type of frame which fixes the textile insert 5 sufficiently in its position in the closed tool against any slipping.

Subsequently, after an opening of the moulding tool, a change of at least one tool half takes place, whilst the so far prepared component remains e.g. in the male die. There follows an association of a second female die with defined stamping edges for the form-fitting seal of the cavity 4, 4′. The material which is to be stamped should be here approximately 0.2-0.3 mm in depth and approximately 1 to 2 mm in width. There now follows the injecting of the second component K2 with low viscosity, and the impregnating of the textile structure 5 with K2, wherein the plastics K1 and K2 connect with one another in a substance-bonding manner to form a composite component, which is surrounded by a thermoplastic edge of K1. The demoulding of the finished component completes the method.

Suitable plastics or resins for an impregnating of a textile insert as second component K2 are e.g. polyurethane systems, epoxy resin systems and in situ polymerisation systems, such as e.g. cast PA, cast PMMA, cast PBT, with low initial viscosities of approximately 5-100 mPa*s. The said plastics or resins, which are not completely listed, are therefore suitable also for the impregnating of tight textile fibre mats. For the production of non-reinforced components or components reinforced with short fibres, on the other hand, resins with viscosities of approximately 100-1000 mPa*s can also be used. Owing to the prevailing internal pressures in particular during the impregnating of tight textile mats, a complete seal of the cavity in the parting plane with a steel-steel pairing of a tool is not possible outside a method according to the invention.

During the injection of the reactive moulding compound K2, an impermeability of the thermoplastic component can now by controlled by a stamping movement of the core 3, so that on the one hand during the injection movement a venting of the cavity 4 is enabled towards the parting plane, and on the other hand on reaching the flow front the cavity 4, by a pressing of the thermoplastic plastic component K1, preferably takes place in the elastic range and thus a complete impermeability of the cavity 4 is achieved.

In a further example embodiment, a fibre composite component is produced by means of the multi-component technique, wherein the method steps run as follows:

According to the illustration of FIG. 2, the moulding tool consists of a first female die 1 and a male die 2. These form together a cavity 4. The female die 1 has a movable core 10, by which a respective size and shape of the cavity 4 is able to be adjusted, as is further described below.

According to an option illustrated in this example embodiment, this cavity 4 is in turn provided with particular geometries for the creation of various functional elements such as flow path aids 8 and ribs 9 or reinforcement elements or similar. Such structural measures for the targeted increase of a rigidity of a component etc. can not be undertaken by a textile structure 5 alone on a fibre composite component. In contrast, a realization by the cavity 4 with connection to the textile structure 5 and the impregnating thermoset component K2 via the thermoplastic component K1 is advantageously possible with large degrees of freedom in the technical configuration.

After the closing of the two tool halves 1 and 2, a plastic component K1 is injected into the arising cavity and is cured. This component is constituted so that in the tool parting plane w a seal is made possible corresponding to the prior art and no or only slight further subsequent processing is necessary after the injection process. This component K1 later constitutes the sealing edge for the elastic sealing of the cavity 4 with respect to a subsequently injected plastic material K2 with low viscosity.

In a second step, the tool is opened in accordance with the illustration of FIG. 3, and second female die 1′ is associated with the male die 2, here, however, the core 10 is displaced in the female die 1 such that a new cavity 4′ forms. A dry textile structure 5 is now inserted into the new cavity 4′ which has thus arisen, see FIG. 3.

With the closing of the tool halves 1 or 1′ and 2, a sealing takes place of the mould part cavity on the plastic material K1. The tolerances are selected here so that on closing of the mould a sufficient seal is achieved with respect to now injected plastics K2 with low viscosity with tool internal pressures of today up to 150 bar.

Subsequently, a moulding compound K2 with a low viscosity can be injected into the now sealed cavity 4′, see FIG. 4. With this component, the impregnating takes place of the textile structure 5 in the tool. The moulding compound K2 cures in the tool. Subsequently, the finished component is demoulded with an opened tool.

Optionally, at this point, in a manner which is not able to be further illustrated in the figures, the filling process with the component K2 is superimposed with a stamping process, which for example can also be controlled via the core 10. Hereby, the venting of the cavity 4′ is controlled with little additional effort.

In an alternative, which is not illustrated further, the method illustrated with the aid of FIGS. 2 to 4 is carried out without the inserting of a dry textile structure 5. Therefore, a seal with a correct contour has been produced in a first step by the material K1, which seal is subsequently largely surrounded with a thermosetting material K2 so that after the curing of the component K2 a composite component results which has a high mechanical load-bearing capacity, with a correct final contour.

Through the two methods described above by way of example, the following advantages are achieved:
distinctly higher degree of freedom of form by injection casting process compared to RTM;
use of cost-efficient semifinished products through the use of dry, non-preimpregnated textiles;
very high potential for lightweight, construction through the combination of material and structural lightweight mode of construction;
no risk of a so-called washout during the injection of the reactive component owing to improved impermeability in the tool parting plane;
no risk of the running ahead of the reactive component on tool edges and hence of the including of air in the workpiece which is to be produced;
no or only very little effort in the subsequent processing of a finished component in the region of the former tool parting plane.

### REFERENCE LIST

1. female die

2. male die

3. core

4. cavity

4′ cavity (produced by displacement of the core 10)

5. textile structure

6. fixing elements

7. empty space/gap

8. flow path aid

9. rib

10. movable core (or second female die with cavity 4′)

b penetration depth of the K1 plastic component into textile structure 5

w tool parting plane between female die 1 and male die 2

K1 plastic component

K2 moulding compound with low viscosity

P arrow of a direction of a movement of a movable core 3

What is claimed is:

1.-12. (canceled)

13. A method for producing plastic components, which have a high mechanical load-bearing capacity, with a correct final contour, said method comprising:
in a first step, performing an injection casting process in a closed tool consisting of a female die and a male die using a first thermoplastic molding compound having a high viscosity, sufficient to create a seal of a cavity of the tool in a tool parting plane between the female die and the male die with respect to a second molding compound having a very low viscosity, used in a second step,
prior to the second step, increasing the cavity is so that after injection and curing of the second molding compound, the seal formed by the first molding compound is fixed on or in the molding compound to such an extent that the first and second molding compounds form a composite component.

14. The method of claim 13, wherein the cavity is increased by adjusting at least one movable block or by associating the male die to another female die, or by an analogous change.

15. The method of claim 13, further comprising inserting a textile structure between the female die and the male die in an open state of the tool, wherein the first thermoplastic molding compound fixes the textile structure in form and position and/or creates a sufficient seal of the tool or of the cavity in the tool parting plane between the female die and the male die with respect to the second molding compound in a second step for impregnating the textile structure.

16. The method of claim 13, further comprising injecting a gas into the first thermoplastic material is used.

17. The method of claim 13, characterized in that the injecting around of the dry textile structure (5) with the thermoplastic plastic (K1) takes place such that the textile structure (5) is partially or completely surrounded by the plastic (K1) and is fixed in a frame-like manner.

18. The method of claim 15, wherein the inserted textile structure forms towards an edge of the cavity an empty space or gap which is adjustable in a defined manner, said space or gap being adjusted in dependence on a ratio of a flow path to wall thickness relationship of the first thermoplast to be processed, and to the existing sprue situation of the tool.

19. The method of claim 13, further comprising stamping or pressing of a circumferential sealing edge formed in the gap after the introduction of the first thermoplast into the cavity said stamping or pressing being implemented by a machine stamping or tool-integrated stamping technique.

20. The method of claim 19, wherein the stamping process is superimposed with the injection of the impregnation component.

21. The method of claim 15, further comprising injecting ribs and other functional elements of the component to be produced directly onto the textile structure.

22. The method of claim 15, wherein the textile structure is fixed in its position in the open state of the cavity by using special elements to prevent an undesired slipping or displacement of the textile structure.

23. The method of claim 15, wherein the special elements comprise needles or push-pull arrangements.

24. The method of claim 15, further comprising
injecting and curing in a separate cavity a thermoplastic material so as to form a structure having ribs and/or reinforcement elements and a seal in the tool parting plane from, wherein the structure, after opening the separate mould, remains in a mould half of the separate mold;
associating a third mould half with the mould half of the separate mould;
forming at least one further cavity with the third mold half;
inserting a dry textile or a textile structure into the further cavity;
closing the mould by means of the third tool half; and
injecting the a plastic with low viscosity into the created cavity, in which the dry textile or the textile structure is situated.

25. The method of claim 13, wherein tolerances of the mould halves are selected by taking the shrinkage of the first thermoplast into consideration so that in a region of the seal of the tool a press fit is established between the tool steel and the first thermoplastic plastic component.
